(19) United States
(12) Patent Application Publication
(10) Pub. No.: US 2003/0135865 A1
(43) Pub. Date: Jul. 17, 2003

(54) Monitoring and management system based on the internet

(76) Inventor: Woni Jung, Seoul (KR)

Correspondence Address: Hae-Chan Park, McGuireWoods LLP, Suite 1800, 1750 Tysons Boulevard, McLean, VA, 22102, US

(21) Appl. No.: 10/315,075

(22) Filed: Dec. 10, 2002

(30) Foreign Application Priority Data
Dec. 10, 2001 (KR) 2001-77812

(51) Int. Cl. H04N 7/173

(52) U.S. Cl. 725/105; 348/211.3

(57) ABSTRACT

A monitoring and management system based on the Internet enables a user to access the Internet with a personal computer (PC) or a video phone at a remote place to check, monitor and manage the current situation of a specific location. The system comprises one or more wireless web cameras each installed at any location where it is required to photograph an object to be monitored and adapted to photograph a moving picture at the photographing location and wirelessly sends out a video signal representative of information regarding the photographed moving picture. A control section is adapted to receiving the video signal from the wireless web cameras and then sends out the received video signal via the Internet through an LAN port. A service provider server receives the video signal from the control section through the Internet for storing the moving picture information corresponding to the received video signal in a database, and provides a home page which assigns a monitoring and management function.

### BACKGROUND OF THE INVENTION

1. Field of the Invention

The present invention generally relates to a monitoring and management system based on the Internet, and more particularly, to a monitoring and management system based on the Internet in which a remote user can access the Internet with a personal computer (PC) or a video phone and check, monitor and manage the current situation of a specific location, e.g., his or her home, a preschool, a private educational institution, an office, or the like, by viewing real-time moving pictures through a service provided to his or her home page.

2. Description of the Related Art

Conventionally, technology has been well known which allows a user to remotely monitor and manage a specific place as described above. This technology may typically include installing a monitoring camera at a specific location to be monitored so as to identify and view information photographed by a camera through a suitable output device (e.g., a monitor) at the remote place.

However, for the conventional prior art, there has been a problem in that the monitoring camera must be installed at the specific monitored location using a fixed-wired manner, which contributes greatly to limitations in installation space and difficulties in installing the camera. As a result, installation cost is very high and specialized maintenance and repair is required accordingly.

Further, there has been an inefficiency in that one PC cannot support various monitoring cameras (hereinafter, referred to as “cameras”). Despite the advent of combined wired and wireless systems, there has been an additional problem in that a user must be inconvenienced with building a multimedia service system personally from expensive equipment components in order for him or her to obtain a monitoring service.

### SUMMARY OF THE INVENTION

It is, therefore, an object of the present invention to solve the above problems and to provide a monitoring and management system based on the Internet which enables innovative construction of the system using wireless web cameras, and simultaneously, the building and provisioning of a home page associated with the monitoring and management system via the Internet. This system will then at any time allow a remote user to check, monitor and manage the current situation of a specific location where the wireless web camera is installed.

Another object of the present invention is to provide a management system, based on the Internet, which enables a remote user to monitor in real time, check, and manage the current situation of a specific location where a camera is installed through a video phone such as a IMT2000.

Another object of the present invention is to provide a monitoring and management system based on the Internet which easily enables a user to personally install a wireless operated camera, i.e., a wireless web camera, in order to avoid any additional cost for construction and installation of the camera equipment.

To achieve the above object of the present invention, there is provided a monitoring and management system based on the Internet, comprising:

one or more wireless web cameras installed at any location where it is required to photograph an object to be monitored and adapted to photograph a moving picture at the photographing location and sending out a wireless video signal representative of information regarding the photographed moving picture and a control section adapted to receives the video signal from each of the plurality of wireless web cameras and then send out the received video signal via the Internet through a LAN port;

a service provider server adapted to receive the video signal from the control section through the Internet for storing the moving picture information corresponding to the received video signal in a database, and adapted to providing a home page, assigning a monitoring and management function to a user for transmitting the moving picture information stored in the database to the home page for allowing it to be displayed on the home page in response to a user request;

a mobile communication service provider adapted to servicing the moving picture information provided by the service provider server to the user through a video phone in response to a user request; and

a user PC adapted to allow the user to access the Internet so that he or she can check, monitor and manage the current situation of the location where each of the wireless web cameras is installed by viewing the moving pictures in real-time on the home page provided by the service provider server.

### BRIEF DESCRIPTION OF THE DRAWINGS

Further objects and advantages of the invention can be more fully understood from the following detailed description taken in conjunction with the accompanying drawings.

FIG. 1 is a block diagram illustrating the construction of a monitoring and management system based on the Internet according to a preferred embodiment of the present invention.

FIG. 2 is a block diagram illustrating the construction of a monitoring and management system based on the Internet according to another embodiment of the present invention.

FIG. 3 is a flowchart illustrating the control process of a monitoring and management system based on the Internet according to the present invention.

### DETAILED DESCRIPTION OF THE PREFERRED EMBODIMENT

The preferred embodiments according to the present invention will now be described with reference to the accompanying drawings.

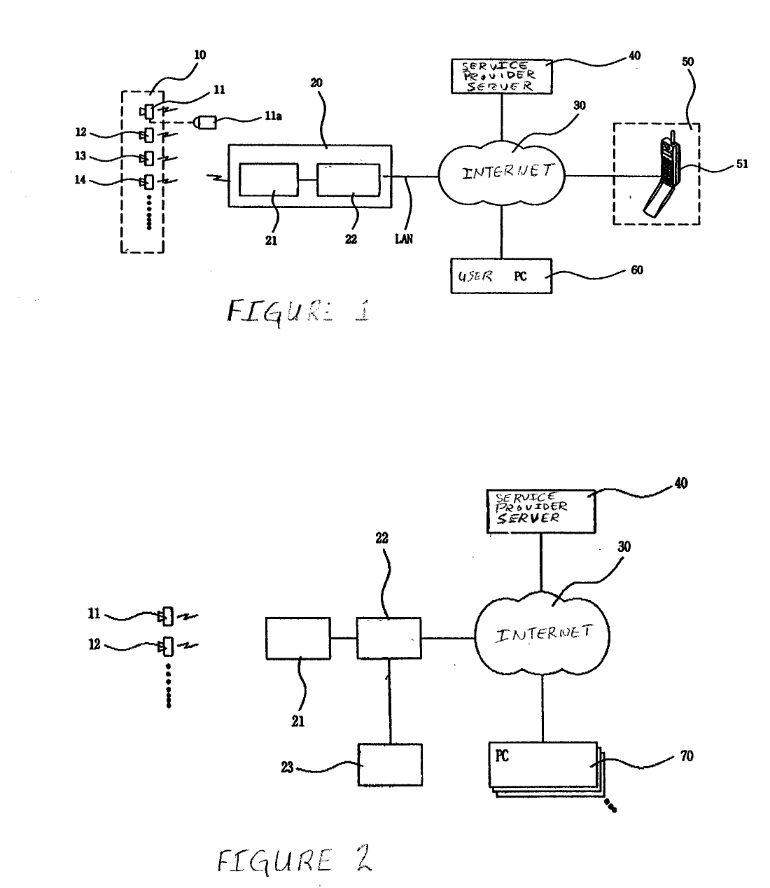

FIG. 1 is a block diagram illustrating the construction of a monitoring and management system based on the Internet according to a preferred embodiment of the present invention.

Referring to FIG. 1, a reference numeral 10 denotes a photographing section consisting of a plurality of wireless web cameras 11, 12, 13, 14, etc., which may be installed at any location where it is required to videotape or photograph an object to be monitored.

Examples of such a photographing location, for illustrative purposes, include various places such as a user's home, an apartment elevator, an office, a private educational institution, a hospital, a specific place in rural communities, and the like. After each of the wireless web cameras 11, 12, etc. has photographed a moving picture at the photographing location, it sends out a video signal representative of information regarding the photographed moving picture in a wireless manner. Also, a wireless infrared motion sensor may be installed at the photographing location where the wireless web cameras 11, 12, etc. are installed so that it can sub-control the operation of the cameras 11, 12, etc. so that the cameras 11, 12, etc. operate only when sensing a moving object.

Reference numeral 20 denotes a control section, which receives the signal representative of information regarding the photographed moving pictures from the photographing section 10 and then transmits it to a service provider server 3 via the Internet 30 through a LAN port.

The control section 20 includes a receiver 21 for wirelessly receiving the video signal from the photographing section 10, and a video signal transmission server 22 for receiving the video signal from the receiver 21 for determining whether or not the received video signal matches a prior video signal of a corresponding location (to determine a change) and for accessing the Internet 30 to transmit the video signal to another corresponding server under the control of the control section 20.

Reference numeral 40 denotes a service provider server 40, which receives the video signal from the control section 20 through the Internet 30 to store the moving picture information corresponding to the received video signal in a database (not shown) thereof. The service provider server 40 also provides a home page and assigns a monitoring and management function to a corresponding user for transmitting the moving picture information that is stored in the database to the user's home page to allow the moving picture information to be displayed in response to a request by the user.

Reference numeral 50 denotes a mobile communication service provider, which services the moving picture information provided by the service provider server 40 to the user through a video phone 51 such as IMT2000. When the user accesses the Internet 30 to check the current situation of the location where each of the wireless web cameras 11, 12, etc. is installed by using the video phone 51, the moving picture information as provided by the service provider server 40 is displayed on the video phone 51 so that he or she can monitor the current real-time situation of the location.

Reference numeral 60 denotes a user PC, which allows the user to access the Internet 30 so that he or she can, in real time, monitor and manage the interior of his or her home, for example, while viewing the moving picture information displayed on the home page provided by the service provider server 40.

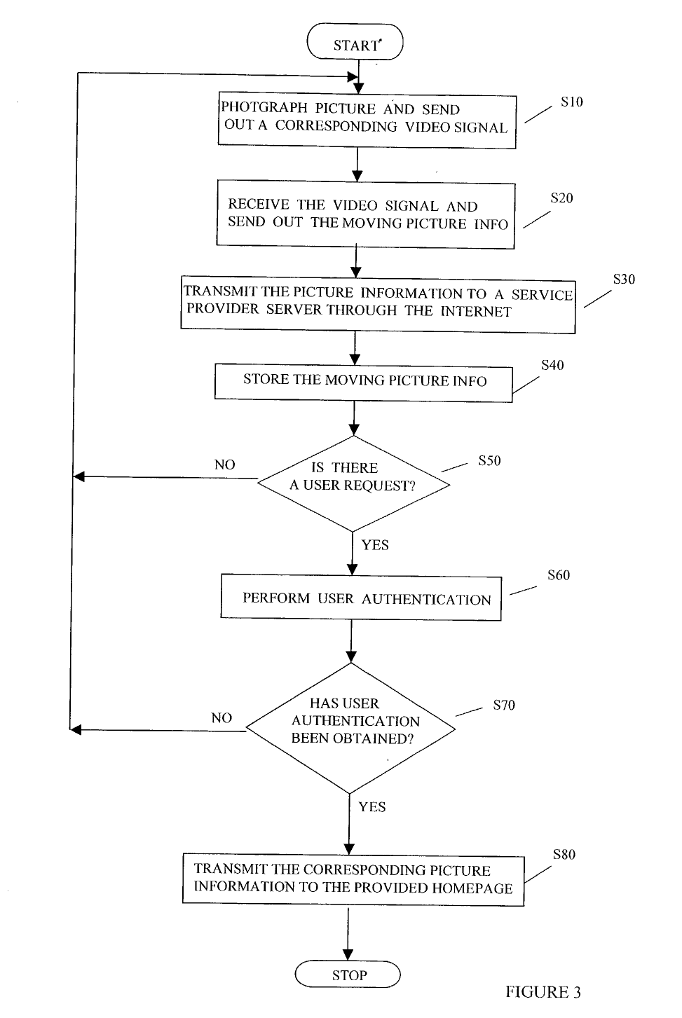

FIG. 2 is a block diagram illustrating the construction of a monitoring and management system based on the Internet according to another embodiment of the present invention. In this illustrative embodiment, each of the wireless web cameras is installed in the interior of an apartment elevator to check, monitor and manage the interior situation thereof.

Referring to FIG. 2, the monitoring and management system includes a plurality of wireless web cameras 11, 12, etc., a receiver 21, a video signal transmission server 22, an internal management PC 23, a service provider server 40 and a PC 70.

Each of the plurality of wireless web cameras 11, 12, etc. is installed at a certain position in the interior of the elevator for photographing a moving picture in the interior of the elevator and sending out a wireless video signal representative of information regarding the photographed moving picture. The receiver 21 wirelessly receives the video signal from each of the plurality of wireless web cameras 11, 12, etc. and then sends out the received video signal. The video signal transmission server 22 receives the video signal from the receiver 21 and determines whether or not the received video signal matches a prior video signal of the corresponding location and then accesses the Internet 30 to transmit the video signal to another corresponding server according to the result of the determination.

The internal management system PC 23 is connected to the video signal transmission server 22 for directly managing the elevator through a moving picture with respect to a moving object photographed in the interior of the elevator.

The service provider server 40 is adapted to receive the video signal from the video signal transmission server 22 through the Internet 30 to store the moving picture information corresponding to the received video signal in a database (not shown) thereof. The service provider server 40 is also adapted to provide a home page, assigns a monitoring and management function to a corresponding user for transmitting the moving picture information that is stored in the database to the home page to be displayed in response to a request of the user. The PC 70 allows the user to access the Internet so that he or she can gain access to the management of the elevator through the home page provided by the service provider server 40.

FIG. 3 is a flowchart illustrating the control process of a monitoring and management system based on the Internet according to the present invention.

As shown in FIG. 3, the monitoring and management controlling method according the present invention includes a series of process steps such as a step of photographing a moving picture at a photographing location and wirelessly sending out a video signal representative of the photographed moving picture information (S10), a step of receiving the video signal for delivery to the video signal transmission server 22 (S20), a step of sending out the video signal to the service provider server 40 through the Internet 30 (S30), a step of receiving the video signal and storing the moving picture information corresponding to the received video signal in a database (S40), a step of determining whether or not there is a user's request to obtain access to the corresponding moving picture (S50), a step of returning to S10 if it is determined that there is no user's request, otherwise undergoing user authentication if it is determined that there is a user's request (S60), a step of determining whether or not the user authentication has been obtained (S70), a step of returning to S10 if it is determined that the user authentication has not been obtained, otherwise transmitting the corresponding moving picture to a home page provided by the service provider server 40 if it is determined that the user authentication has been obtained (S80).

The following explanation on the operation of the present invention as constructed above will be given in detail with reference to FIG. 3.

Beginning with step S10, each of the plurality of wireless web cameras 11, 12, etc. photographs a moving picture at a specific location to be monitored and managed and wirelessly transmits a video signal representative of the photographed moving picture information to the control section 20. The program proceeds to step S20 in which the receiver 21 of the control section 20 receives the video signal from each of the plurality of wireless web cameras 11, 12, etc. for application to the video signal transmission server 22. Herein, the plurality of wireless web cameras 11, 12, etc. and the control section 20 are equipment installed at any location to be photographed. Then, the program proceeds to subsequent step S30 where the video signal transmission server 22 of the control section 20 accesses the Internet 30 through a LAN, or equivalent, and then transmits the video signal to the service provider server 40. Subsequently, at step S40, the service provider server 40 receives the video signal and stores the moving picture information corresponding to the received video signal in a database thereof.

In the meantime, the plurality of wireless web cameras 11, 12, etc. are installed a specific location to be monitored and managed, and the service provider server 40 provides a home page and assigns a monitoring and management function to the user. At this time, at step S50, it is determined whether or not there is a user's request to access the corresponding moving picture (S50). If it is determined at S50 that there is no user's request, the program returns to step S10. On the other hand, it is determined at S50 that there is a user's request, i.e., when the user desires to use or view the moving picture information, the program proceeds to step 60 where he or she accesses the service provider server 40 via the Internet 30 using the video phone 51 of the mobile communication service provider 50, which allows his or her home page to be displayed on a screen of the video phone 51. Then, the service provider server 40 performs user authentication in order to validate a user's identity and the program proceeds to step S70 where the service provider server 40 determines whether or not the user authentication has been obtained. If it is determined at step S70 that the user authentication has not been obtained, the program returns to step S10. If, on the other hand, it is determined at S70 that the user authentication has been obtained, i.e., the user's identity has been validated, the program proceeds to step S80 where the service provider server 40 provides the corresponding moving picture information to the user's home page and displayed on a screen of the video phone 51. At this time, the user can, in the form of moving pictures in real time, monitor the current situation of the specific location where the wireless web cameras 11, 12, etc. are installed using the monitoring and management program provided on the home page. At this time, the identified moving picture information is contents, which can be provided by the service provider server 40.

Accordingly, the user can, in real time, check, monitor and manage the current situation occurring at his or her home, a school, an office, a preschool, a private educational institution, a hospital, or the like.

As described above, according to the monitoring and management system based on the Internet of the present invention, a user can identify or monitor the moving pictures photographed by a wireless web camera installed at home or an office through a cellular phone (video phone) at a remote place.

Further, according to the present invention, several problems are eliminated. When a user must replace an old camera with a new camera, e.g., in the case of obligatory trends to install cameras in the interior of apartment elevators, the task is much more simple and less complicated with wireless cameras as compared with wired cameras. Installation costs are often less with wireless cameras. Wired cameras, on the other hand, are often much more difficult to install in places such as elevators and may even be impossible to install. In this case, the wireless cameras of the present invention have an advantage over wired cameras. Moreover, a user can, always in real time, identify and monitor the current situation occurring at a small nursery school, a preschool, a private educational institution, etc.

Furthermore, the present invention has an addition advantage in that it is possible to easily install a wireless camera at a location where it is difficult to place a wired camera and its installation cost is typically much less than that of the wired camera.

While this invention has been described in connection with what is presently considered to be the most practical and preferred embodiment, it is to be understood that the invention is not limited to the disclosed embodiment, but is intended to cover various modifications, variations or equivalents within the spirit and scope of the appended claims.

Having thus described our invention, what we claim as new and desire to secure by Letters Patent is as follows:

1. A monitoring and management system based on the Internet, comprising:
one or more wireless web cameras each installed at any location where it is required to photograph an object to be monitored and adapted to photograph a moving picture at the photographing location and send out a video signal representative of information regarding the photographed moving picture in a wireless manner;
a control section adapted to receive the video signal from one or more wireless web cameras for sending out the received video signal via the Internet;;
a service provider server adapted to receive the video signal from the control section through the Internet for storing the moving picture information corresponding to the received video signal in a database, and adapted to providing a home page and assigning a monitoring and management function to a user for transmitting the moving picture information stored in the database to the home page to allow it to be displayed on the home page in response to user request;
a mobile communication service provider adapted to service the moving picture information provided by the service provider server to the user through a video phone in response to the user request; and
a user personal computer (PC) adapted to allow the user to access the Internet so that the user can check, monitor and manage the current situation of the location where one or more wireless web cameras is installed by viewing the moving pictures in real-time on the home page.

2. The monitoring and management system according to claim 1, wherein the control section includes a receiver for wirelessly receiving the video signal from the photographing section, and a video signal transmission server for receiving the video signal from the receiver to determine whether or not the received video signal matches a video signal of a corresponding location and for accessing the Internet to transmit the video signal to another server.

3. The monitoring and management system according to claim 1, wherein a wireless infrared sensor is installed at the photographing location where one or more wireless web cameras is installed for sub-controlling the operation of the one or more wireless web cameras only when sensing a moving object.

4. The monitoring and management system according to claim 2, wherein the video signal transmission server further comprises an internal management system PC for directly managing the elevator through a moving picture with respect to a moving object photographed in the interior of the elevator.

5. A method for monitoring and managing based on the Internet, the method comprising the steps of:
photographing in real-time moving pictures using one or more wireless web cameras;
sending a wireless video signal of the moving pictures from the wireless web cameras, the wireless video signal including video information representative of the moving pictures;
receiving the video information from the one or more wireless web cameras at a control section;
sending the video information to a service provider using the Internet; and
storing the video information in a database; and
retrieving the video information upon a user request for displaying the video information.

6. The method according to claim 5, further comprising the steps of:
servicing the video information by a mobile communication service provider; and
displaying the video information on a video phone.

7. The method according to claim 5, further comprising the step of sub-controlling the one or more wireless web cameras so that the one or more wireless web cameras operate only when motion is detected by a motion detector.

8. The method according to claim 5, further comprising the step of determining whether the received video information matches a prior corresponding video signal.

9. The method according to claim 5, further comprising the steps of:
providing a homepage on the Internet associated with the user and for displaying the video information; and
transmitting the video information to the homepage.

10. The method according to claim 9, further comprising the step of performing user authentication for accessing the homepage.
